(19) United States
(12) Patent Application Publication
(10) Pub. No.: US 2026/0187106 A1
(43) Pub. Date: Jul. 2, 2026

(54) SYSTEMS AND METHODS FOR THE GENERATION, UPDATE, AND USE OF MODELS FOR SENTIMENT ANALYSIS OF CONTENT

(71) Applicant: Handraise, Inc., Austin, TX (US)

(72) Inventors: David Francis Perdue, Austin, TX (US); William Wesley Yeats Beaver, Austin, TX (US); Nathan Dane Walker, Austin, TX (US); Matthew John Allison, Driftwood, TX (US)

(21) Appl. No.: 19/420,871

(22) Filed: Dec. 16, 2025

Related U.S. Application Data
(60) Provisional application No. 63/739,914, filed on Dec. 30, 2024.

(51) Int. Cl. G06F 16/332; G06F 16/338

(52) U.S. Cl. CPC G06F 16/3326; G06F 16/338

(57) ABSTRACT

Systems and methods for sentiment analysis of content are disclosed. Using a LLM, embodiments can take content and determine a sentiment polarity, and intensity for the term with respect to the contextual use of the term within the content. Moreover, embodiments may determine a rationale for why or how the polarity or intensity were determined.

### RELATED APPLICATION(S)

This application claims a benefit of priority to the filing date of U.S. Provisional Patent Application Ser. No. 63/739,914 by inventors David Perdue et al, entitled “SYSTEMS AND METHODS FOR THE GENERATION, UPDATE, AND USE OF MODELS FOR SENTIMENT ANALYSIS OF CONTENT” filed on Dec. 30, 2024, the entire contents of which are hereby expressly incorporated by reference for all purposes.

### TECHNICAL FIELD

This disclosure relates generally to improved systems and methods for the analysis of content, including media or the like. More particularly, this disclosure relates to embodiments of a model based approach to the analysis of content as it relates to the sentiment of such content, including the generation, update and use of such models in finding and analyzing the sentiment present in such content. Even more specifically, this disclosure relates to embodiments of systems and methods for the generation and update of Large Language Models (LLM) and associated prompts based on an analysis of content, the updating of such an models and prompts, and the use of such models and prompts in the analysis of content to increase the accuracy of sentiment classification of that content by providing context-aware analysis and rationales for such sentiment classification.

### BACKGROUND

In the online space the analysis of content is difficult. Large organizations may be especially interested in the analysis of online content. Specifically, enterprises may be concerned with, and may desire to closely monitor, content associated with those enterprises (or aspects thereof).

Thus, enterprises may employ sentiment analysis for monitoring such content or otherwise determining how certain terms associated with the enterprise are being utilized. Sentiment analysis is a process of using natural language processing (NLP) or other techniques to evaluate and determine the emotional tone or attitude expressed in a piece of content. When it comes to enterprises, sentiment analysis is especially valuable because it allows companies to gauge, perceive or analyze how aspects of their enterprise are perceived by consumers of online content.

Assessment of content with respect to sentiment related may be a difficult proposition for a variety of reasons, not the least of which is the lexical complexity of languages. In particular, tone and sentiment may be quite subjective and requires context. Accordingly, the current methods for the sentiment analysis of content have proved woefully inadequate in meeting the desires of enterprises or other entities with respect to assessing online content.

What is desired, therefore, are improved systems and methods for sentiment analysis, and, in particular, improved sentiment analysis systems and methods that can provide more accurate, context-aware sentiment analysis of content including rationales for such sentiment classification or analysis.

### SUMMARY

As discussed, the analysis of content for sentiment is quite difficult. Current sentiment analysis tools may employ algorithms that can scan through content to determine sentiment using various techniques. Once the content is analyzed, the sentiment is usually provided as a single score based on pre-set criteria. This type of scoring system is opaque. Moreover, the sentiments generated by these sentiment analysis tools are often inaccurate. This is at least because current sentiment analysis tools have problems with understanding the full context of a piece of content or with mixed sentiment in a piece of content.

Because of the problems with current sentiment analysis tools, users cannot rely on the sentiments or other data produced by these tools and either ignore it, or resort to manual review or content to determine sentiment associated with that content as it related to the enterprise.

What is desired, therefore, are improved systems and methods for sentiment analysis, and, in particular, improved sentiment analysis systems and methods that can provide more accurate, context-aware sentiment analysis of content including rationales for such sentiment classification or analysis.

To those ends, among others, embodiments as disclosed herein may provide systems and methods for sentiment analysis that may utilize LLMs and dynamic prompts to provide accurate, context-aware sentiment analysis of content including rationales for such sentiment classification or analysis. In particular, embodiments may take as input one or more terms along with a type of each term or a description of the meaning that term.

These terms and associated part of a description may be part of a feed for an enterprise provided by a sentiment analysis system such that content may be monitored for those terms. Using a LLM, embodiments can take content and determine a sentiment polarity (e.g., positive, neutral, negative) and intensity (e.g., scored from 1 to 5) for the term with respect to the content. Moreover, embodiments may determine a rationale for why the polarity or intensity were determined to be these specific values.

Specifically, embodiments may use a dynamic prompt structure that constructs a prompt to the LLM utilizing the term, associated type, and associated description, where that prompt may be adapted to generate a response from the LLM including the sentiment polarity, intensity for the keyword, or rationale (e.g., associated with the content). This prompt may also include the content itself.

Thus, embodiments may determine, or account for, a distinction between the overall sentiment of the content and the sentiment of how the term is used in context within the content. Accordingly, embodiments account for the context of the appearance of the term and are able to discern subjective contextual meaning when determining sentiment in relation to the keywords, providing a more accurate, context-relevant measurement of sentiment for that keyword as it relates to the content.

In one embodiment, a definition for a feed associated with content received from one or more data sources may be obtained. This feed definition can comprise a term, a term type, and a term description.

The feed definition can also include the specification of (or context related to) a target audience. This target audience may include a definition of one or more audiences (e.g., employees, customers, investors, regulators, journalists, etc.) for which sentiment data should be determined. Content associated with the feed can be determined and a sentiment polarity and a sentiment intensity for the term with respect to the first content determined. In embodiments where one or more target audiences is included in the feed, a sentiment polarity and sentiment intensity may be determined for each, or with respect to each, of the target audiences. The sentiment intensity and sentiment polarity for a target audience may reflect a determination of sentiment intensity and sentiment polarity that would be held by that target audience (e.g., how members of that target audience would view that content).

The determination of the sentiment polarity and a sentiment intensity may include generating a first prompt for the first content based on the feed using the term, term type, and term description, where the first prompt is adapted to cause a Large Language Model (LLM) to generate the sentiment polarity and sentiment intensity for the first content based on the contextual use of the term in the first content, and submitting the generated first prompt to the LLM. The first prompt may also include target audience context for any target audiences that are included in the feed definition such the prompt is adapted to provide these target audience contexts to the LLM and cause the LLM to generate the sentiment polarity and sentiment intensity for the first content according to those target audiences. The first prompt can also be adapted cause the LLM to generate a rationale for the sentiment polarity or sentiment intensity, including a rationale that may be specific for each of the target audiences included in the feed.

In some embodiments, generating the first prompt comprises modifying a generic prompt to generate a tailored prompt based on the term, term type, term description and any included target audiences of the feed.

In certain embodiments, generating the tailored prompt comprises presenting the first prompt to the user, receiving a modification to the first prompt from the user, and modifying the first prompt according to the modification received from the user. Generating the tailored prompt may also include obtaining sentiment data for a dataset of positive sentiment content or negative sentiment content and including the dataset in the tailored prompt. These datasets of sentiment content may also be specific to any target audiences included in a feed, such that there may be (e.g., different) positive sentiment content or negative sentiment content associated with These datasets (e.g., positive or negative sentiment content or target audience specific positive or negative sentiment content) can, for example, be provided by a user with respect to the term.

Particular embodiments may also include storing the tailored prompt as an enterprise and feed specific prompt. When content (e.g., subsequent content) associated with the feed is next obtained the sentiment polarity and the sentiment intensity for the term with respect to this new content can be determined by obtaining the enterprise and feed specific prompt and generating a second prompt for the second content based on the enterprise and feed specific prompt using the term, term type, and term description, where the second prompt is adapted to cause the LLM to generate the sentiment polarity and sentiment intensity for the second content based on the contextual use of the term in the second content. This second prompt can be submitted to the LLM to generate the sentiment polarity and sentiment intensity.

In some instances, the enterprise and feed specific prompt may be updated based on output of the LLM in response to submitting the first prompt to the LLM. This update may entail updating the enterprise and feed specific prompt based on user feedback on the sentiment polarity and sentiment intensity for the first content generated by the LLM.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIGS. 1A-1C are block diagrams of embodiments of a system and architecture for a sentiment analysis system.

FIGS. 2A-2D are examples of interfaces that may be utilized or presented by embodiment of a sentiment analysis system.

FIG. 3 is a flow diagram of one embodiment of a method for sentiment analysis.

FIGS. 4A-4C are examples of interfaces that may be utilized or presented by embodiment of a sentiment analysis system.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

In the online space where content is widely distributed, and turnover of content is frequent, the analysis of such content is difficult. These circumstances have not, however, made the accurate analysis of content (e.g., online or other content, also referred to without loss of generality as media) any less desirable. A microcosm of this problem occurs in the context of enterprises' (e.g., companies or any other for profit or non-profit entity) and online media.

Specifically, enterprises may be concerned with, and may desire to closely monitor, how their brand, products, or services (e.g., generally terms associated with the enterprise) are being mentioned or used in various media or other forms of content. This evaluation helps enterprises track public opinion and manage their brand reputation. In particular, understanding how an enterprise (or terms associated therewith) is discussed and talked about in media is important for corporate communications professionals. These enterprises have goals or desires related to how the enterprise is discussed or mentioned. It may be desirable to determine how an enterprise is discussed to see if those goals are being met, and in the case where the enterprise is being talked about negatively, those associated with the enterprise need to be able to ascertain this quickly and react to influence or ameliorate the tone and message.

Thus, enterprises may employ sentiment analysis for monitoring such content or otherwise determining how certain terms associated with the enterprise are being utilized. Sentiment analysis is a process of using natural language processing (NLP) or other techniques to evaluate and determine the emotional tone or attitude expressed in a piece of content. When it comes to enterprises, sentiment analysis is especially valuable because it allows companies to gauge how their brand is perceived by the public in various online media such as social media, blogs, news articles, reviews, and forums.

Thus sentiment analysis helps enterprises understand how their brand (e.g., terms associated with the enterprise) is being perceived and how it changes over time. If negative sentiment is detected, enterprises can take corrective actions, such as responding to customer complaints, addressing concerns, or modifying their marketing strategies.

Specifically, by analyzing sentiment, enterprises can gain insights into what their customers like or dislike about their products or services, giving them valuable feedback for product development and customer service improvements. Enterprises can also track sentiment related to competitors and assess how they are positioned in comparison. This can help identify opportunities and threats in the market. Sentiment analysis can also be particularly valuable in crisis situations. If there is an abrupt shift in sentiment due to a product recall, scandal, or negative media coverage, enterprises can quickly respond and mitigate potential damage.

Assessment of media or other content with respect to sentiment related to an enterprise may be a difficult proposition for a variety of reasons, not the least of which is the lexical complexity of languages. In particular, tone and sentiment may be quite subjective and requires context.

Accordingly, the current methods for the sentiment analysis of content have proved woefully inadequate in meeting the desires of enterprises or other entities with respect to assessing online content. This leads to a mistrust in the data, and in a lot of cases, a significant investment of time and manual effort to achieve even a small degree of accuracy.

To illustrate in more detail, sentiment analysis tools may employ algorithms that can scan through this content and determine the tone associated with mentions of an enterprise. These algorithms use techniques like tokenization, part-of-speech tagging, and models to identify keywords, phrases, or sentences that suggest a positive or negative sentiment.

Once the content is analyzed, the sentiment is usually scored based on pre-set criteria (positive, neutral, negative). For example, words like “excellent” or “horrible” are easily classified based on their association. Sentiment for these terms can then be aggregated into a single sentiment score (e.g., ranging from −1 to +1 where negative numbers represent negative sentiment, positive numbers represent positive sentiment, and zero represents neutral sentiment.). This type of scoring system is opaque. There is little to no visibility into why a certain piece of media is classified as positive, neutral, or negative.

Additionally, and importantly, the scores and sentiments generated by these sentiment analysis tools are often inaccurate. This is because current sentiment analysis tools have a number of problems. As but one problem, sentiment analysis tools can struggle with understanding the full context of a piece of content. For instance, tone, slang, sarcasm, irony, or humor can lead to misinterpretations of the sentiment of such content.

A particular case where these sentiment analysis tools struggle is with understanding the subtlety of mixed sentiment. A single piece of content might contain both positive and negative elements. In this case, the overall sentiment score may not reflect the nuanced sentiment of the entire content. For example, an article may highlight a enterprises new product, praising its features, but also criticize the enterprise's environmental practices or the enterprise may be mentioned positively within a piece of content, but the overall tone or subject matter of the content is negative (e.g., the Red Cross is mentioned in a positive light in the context of an article on a horrific disaster). These situations may lead to a sentiment score that does not fully capture the mixed sentiment of that content.

Sentiment analysis systems may have issues with this type of mixed sentiments as sentiment analysis algorithms, especially if they rely on superficial keyword matching or sentence-level sentiment classification, may struggle to recognize this complex dynamic. In no small part this is because current sentiment analysis systems typically cannot account for context (e.g., they evaluate sentiment of isolated portions of content).

Specifically, sentiment analysis tools often evaluate sentiment sentence by sentence, and thus a sentence like “Enterprise's X's new product is wonderful” may get a positive sentiment score, even if the surrounding context (e.g., “But despite these efforts, their treatment of employees and environmental record are a complete disaster”) is negative. This can cause sentiment analysis systems to categorize this content with an overall positive sentiment, even though the negative tone or the subject matter outweighs the positive sentiment in the content. Generally then, many sentiment analysis tools do not have a way to relatively weight or compare the importance of various segments within an article, often leading to incorrect sentiment analysis.

Because of the problems with current sentiment analysis tools, enterprises (e.g., communication professionals or others associated with the enterprise) have lost trust in the sentiments or other data produced by these tools and either ignore it, or resort to manual review or content to determine sentiment associated with that content as it related to the enterprise.

What is desired, therefore, are improved systems and methods for sentiment analysis, and, in particular, improved sentiment analysis systems and methods that can provide more accurate, context-aware sentiment analysis of content including rationales for such sentiment classification or analysis.

To those ends, among others, embodiments as disclosed herein may provide systems and methods for sentiment analysis that may utilize LLMs and dynamic prompts. In particular, embodiments may take as input one or more keywords or terms (used here interchangeably) relevant to an enterprise (e.g., names, brands, product names, phrase, etc.) along with a type of each keyword (e.g., (organization, person, location, etc.) or a description of the meaning that keyword (referred to as a description or term description interchangeably without loss of generality). Embodiments may also take as input any target audiences desired for such sentiment analysis

These terms or associated terms or description may be part of a feed for an enterprise provided by a sentiment analysis system such that content (e.g., media or other online content) received (e.g., from one or data sources associated with the feed or otherwise determined or located) may be (e.g., substantially continuously) monitored for those terms for an enterprise as that content is received or located, and sentiment data associated with those terms provided to the enterprise in an ongoing manner.

Using a LLM, embodiments can take content and determine a sentiment polarity (e.g., positive, neutral, negative) and intensity (e.g., scored from 1 to 5) for the keyword with respect to the content. In embodiments where one or more target audiences is included in the feed, a sentiment polarity and sentiment intensity may be determined for each, or with respect to each, of the target audiences. The sentiment intensity and sentiment polarity for a target audience may, for example, reflect a determination of sentiment intensity and sentiment polarity that would be held by that target audience Moreover, embodiments may determine a rationale for why the polarity or intensity were determined to be these specific values. In some cases, there may be a rationale that may be specific for each of the target audiences included in the feed.

Specifically, embodiments may use a dynamic prompt structure that constructs a prompt to the LLM utilizing the keyword (term), associated type, and associated description, where that prompt may be adapted to generate a response from the LLM including the sentiment polarity, intensity for the keyword, or rationale (e.g., associated with the content). When target audiences are included in feed, the prompt may include the target audience and any associated target audience context in the prompt such that the prompt may be adapted to generate a response from the LLM including the sentiment polarity, intensity for the keyword with respect to each target audience of the feed, or a rationale (e.g., associated with the content) for each of the target audiences.

The prompt may also include the content itself. The prompt can then be provided to the LLM to generate the desired response, allowing the LLM to determine the sentiment relative to the keyword as it relates to the content (e.g., for each target audience when a target audience is part of the feed) and may include the intensity and rationale (e.g., for each target audience when a target audience is part of the feed).

Moreover, these prompts may be stored in association with the enterprise (or feed for the enterprise) to generate an enterprise and feed specific prompt that may be continually updated based on the output of the LLM or input provided by a user, or other contextually relevant data. By utilizing, and updating, such enterprise and feed specific prompts the accuracy and quality of the sentiment polarity, score or rationale may be continuously improved.

As can be seen then, embodiments may determine, or account for, a distinction between the overall sentiment of the content and the sentiment of how the keyword is used in context within the content. Additionally, this may be done in a target audience aware or non-target audience aware manner (e.g., even in cases where a target audience may be included in the feed), such that the sentiment of how the keyword is used in context within the content may be determined through the lens of specific target audiences.

Accordingly, embodiments account for the context of the appearance of the keyword and are able to discern subjective contextual meaning when determining sentiment in relation to the keywords, including the subjective contextual meaning as it may relate to different target audiences, providing a more accurate, context-relevant measurement of sentiment for that keyword as it relates to the content.

Before delving into more detail regarding the specific embodiments disclosed herein, it will be helpful to remember the context described above. Additionally, it will be understood throughout this disclosure that though in certain instances embodiments and examples have been described with respect to media or online content, this type of content are only particular examples of content and should be viewed interchangeably with content generally for purposes of those descriptions. In other words, any descriptions given herein with respect to a particular type of content (e.g., such as media) do not serve in any way as restrictions on those embodiments or examples applicability to content generally, and should in no way be viewed as restrictions on those embodiments or examples.

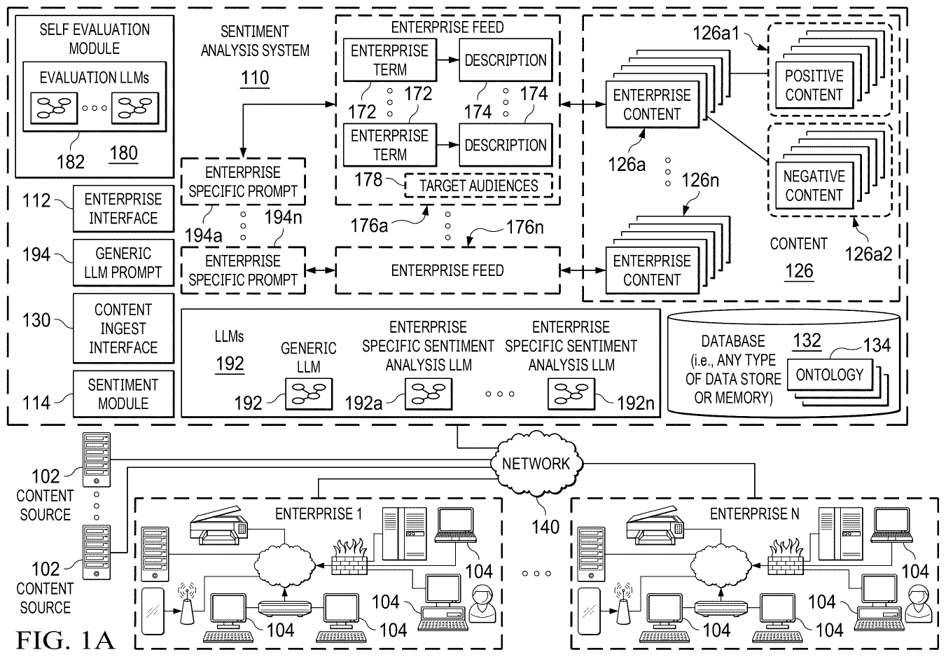

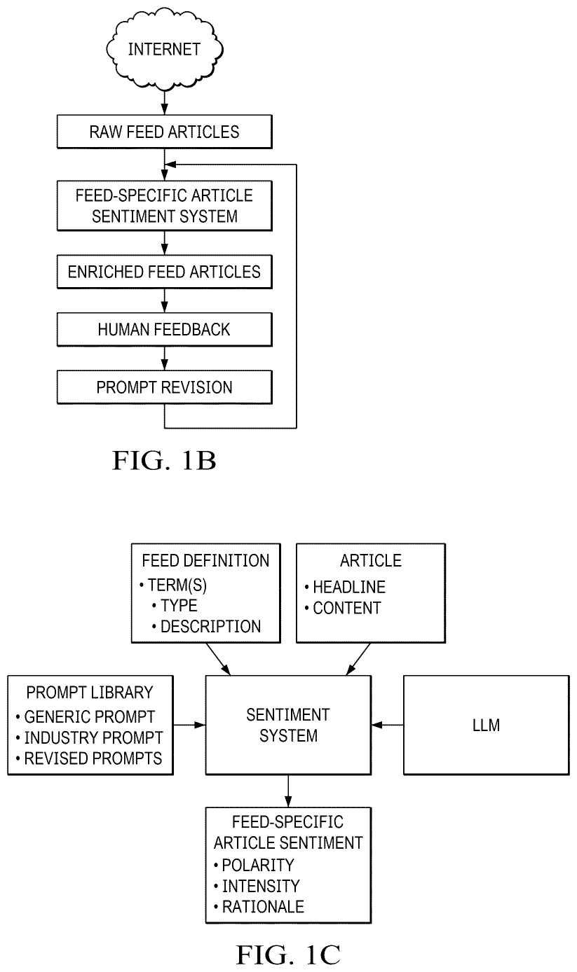

Referring to FIGS. 1A-1C then, embodiments of an architecture in which embodiments of sentiment analysis systems may be deployed are depicted. Sentiment analysis system 110 is coupled to one or more user device 104 and content sources 102 over network 140. Network 130 may be the Internet, an intranet, a wireless or wired network, a Local Area Network (LAN), a Wide Area Network (WAN), some combination of these types of computer based networks, etc.

Sentiment analysis system 110 may include enterprise interface 112 through which input from users (at user devices 104) within an enterprise may be received and through which (e.g., sentiment or other) data determined by sentiment analysis system 110 may be provided. Thus, users associated with an enterprise may provide input though enterprise interface 112 where that input comprises one or more keywords or terms (used here interchangeably) relevant to an enterprise (e.g., names, brands, product names, phrase, etc.) along with a type of each term (e.g., (organization, person, location, etc.) or a description of the meaning that term. This description may be a short (e.g., 5 or 10 words of natural language) description of an associated term that provides a further definition of the associated term. For example, it could be a definition of who when the term is a name (e.g., “Joe Smith is CEO of Acme Corporation”) or a description of the term as an enterprise's name (e.g., “Acme is a company that designs and develops rocket powered roller skates.”).

Enterprise interface 112 may also be used to provide a specification of a target audience (or target audience context data). This target audience may include a definition of one or more audiences (e.g., employees, customers, investors, regulators, journalists, etc.) that may consume content related to an enterprise.

Thus, the terms 172 and associated descriptions 174 (e.g., a type or associated description or definition of that term) along with any target audiences provided may be stored at sentiment analysis system 110 in association with (e.g., an identifier for) the enterprise. Thus, a feed 176 (e.g., 176a, 176n, etc.) may be associated with each enterprise where the feed 176 for an enterprise may include a set of (one or more) terms 172 provided by users of that enterprise and associated descriptions 174 for each of those terms 172. The feed 176 may also include any target audiences 178 for that feed (e.g., provided by the user). The feed 176 or associated description of a term may also include or be associated with, for example, specific examples or definitions of what could be considered positive or negative sentiment for that particular feed or a particular term. These specific examples or definitions of what could be considered positive or negative sentiment for that particular feed or particular term may also be specific to any target audiences 178 included in a feed 176.

Content sources 102 may be providers of content (e.g., media, articles, blog posts, or other electronic documents or files) that may be accessed in a variety of manners. For example, a content source 102 may be a content aggregator collecting media from other locations (e.g., from particular web sites) or may be an original generator of such content (e.g., a digital publisher, blogging platform, etc.).

Accordingly, content sources 102 may provide different methods through which the content they provide may be accessed. For example, a content source 102 may provide a web service or the like through which a user (e.g., a machine or human user) of the content source 102 can register such that the user can receive a feed or otherwise be sent content at certain intervals (e.g., nightly, weekly, etc.). This content from content sources 102 may be content of almost any format, including textual content, audio content, video content, etc. For example, a single piece of content may be an article containing such things, as headlines, leads (e.g., the first paragraph of an article), a body (the contents of the article excluding the title, byline and headlines, etc.). For ease of reference herein, a single discrete piece of content may be referred to as an article. It should be understood however, that this term is used for ease of reference only and that embodiments as disclosed herein may be applied equally well to almost any type of content regardless of format or other characteristics.

Sentiment analysis system 110 includes content ingest interface 130 through which articles from the content sources 102 can be received (or retrieved) over network 140. These articles may, or may not, be received with accompanying metadata that indicates an author, an original source publication, a time of publication, or other information. Content ingest interface 130 may then save this content 126 (articles) to content data store 124.

As discussed, sentiment analysis system 110 may be registered with a content source 102 and that content source 102 may provide articles to content ingest interface 130 of the system 110 at certain intervals. This content ingest interface 130 may itself include a web service or have access to location where articles are sent by the content source 102.

Additionally, or alternatively, content 126 associated with an enterprise may be obtained from content sources 102 using the enterprise feed 176 associated with an enterprise. Specifically, the terms 172 (e.g., and descriptions 174) may be utilized to search content sources 102 (or content from content sources 102) for content 126 related to those terms 172 (or descriptions 174). It will be noted that particular content sources 102 or types of content may also be defined with respect to an enterprises feed 176. Thus, content 126 may include content 126 including enterprise content feeds 126a, 126n, etc. associated with each enterprise and determined from terms 172 or descriptions 174 of that enterprise's feed. In these embodiments, then, it may be the case that articles in an enterprise content feed 126a, 126n may include one or more of the terms 172 of the enterprise's feed 176.

Sentiment analysis system 110 also includes sentiment module 114. Sentiment module 114 is adapted to analyze content to determine a sentiment polarity (e.g., positive, neutral, negative) or intensity (e.g., scored from 1 to 5) for the keyword (i.e., term) with respect to content 126 (e.g., content 126 of an enterprise content feed 126a, 126n associated with an enterprise feed 176). Moreover, sentiment module 114 may determine a rationale for why the polarity and intensity were determined to be those specific values.

When target audiences 178 are included in feed 176, the sentiment module 114 may be adapted analyze content to determine a sentiment polarity (e.g., positive, neutral, negative) or intensity (e.g., scored from 1 to 5) for the keyword (i.e., term) with respect to content 126 with respect to each target audience 178 of the feed 176, or a rationale for why the polarity and intensity were determined to be those specific values for each of the target audiences 178.

This sentiment data for content 126 may be presented to a user through enterprise interface 112 such that a user (at user device 104) may be able to access the content 126 and the associated sentiment data determined for the terms 172 of that enterprises'feed 176 related to that content 126, and to interact with, or provide associated user sentiment data. Appendix A presents examples of a term and associated description, generated prompts for an LLM based on this term and description and associated example output that may be generated from a sentiment analysis system based on such a prompt. Two presented prompts in Appendix A include a prompt adapted for determining sentiment data with respect to one, or multiple, target audiences (e.g., “stakeholders”) by including an audience context in the prompt such that the sentiment polarity, intensity, or rationale may be determined with respect to the one or more audiences (e.g., “stakeholders”).

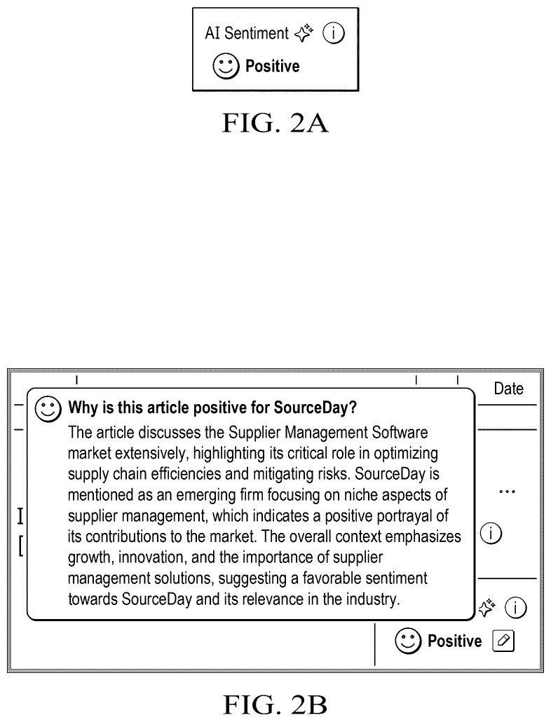

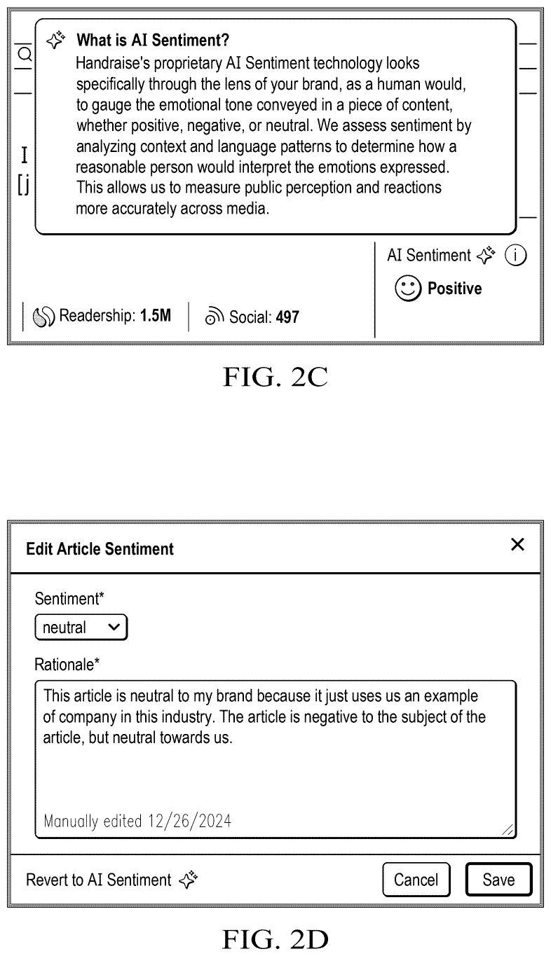

FIGS. 2A-2C depict examples of interfaces for interacting with a sentiment analysis system. For example, FIG. 2A depicts an example interface for providing sentiment data about an article to a user. FIG. 2B depicts an example interface for providing sentiment data for an article to a user, including a rationale for why a sentiment polarity or intensity was determined. FIG. 2C depicts an example interface presenting a user with a description of the operation of a sentiment analysis system to allow a user a better understand the process of sentiment analysis by such a sentiment analysis system.

Returning to FIG. 1, as can be seen, the sentiment data determined for content 126 may be related specifically to the terms 172 provided by (and of interest to) the enterprise (e.g., for that enterprise's feed 176), including a definition of positive or negative sentiment (e.g., for a feed 176 or a particular term 172 of that feed 176). Moreover, the sentiment module 114 may take into account the context of the article associated with the appearance of those terms 172 in that article. Additionally, the sentiment data may be specific for target audiences provided by (and of interest to) the enterprise (e.g., for that enterprise's feed 176).

In one embodiment, therefore, to determine sentiment data related to a term 172 of an enterprise's feed 176, sentiment module 114 may utilize the term 172, the description 174 of the term 172, and content 126 of the article itself to generate a prompt to a large language model (LLM) 192. Additionally, if desired, target audience context associated with any provided target audiences 178 may also be included the generated prompt.

For example, sentiment analysis system 110 may include a generic prompt 194 which may comprise a set of text that may be used for a prompt for an LLM. This generic prompt 194 may be utilized such that it can be modified or added to based on the term 172, the description 174 of the term 172 and the content 126 of the article to generate a tailored prompt adapted for determining the desired sentiment data (e.g., sentiment polarity, intensity and rationale) for that term 172 with respect to that article. For example, the generic prompt 194 may include a set of generic text with locations (e.g., placeholders) where an article headline, article text, term 172, description 174, etc. may be included or inserted to generate a tailored prompt for that term 172 and that article.

This tailored prompt can then be submitted to LLM 192. This LLM 192 may be a generic LLM or may be an LLM trained on content 126 determined by sentiment analysis system 110 or by some other methodology. The LLM 192 can then take this tailored prompt and return the sentiment data (e.g., the sentiment data which the tailored prompt is adapted to produce). As discussed, this sentiment data produced by submitting the tailored prompt to LLM 192 may be presented to a user through enterprise interface 112 such that a user (at user device 104) may be able to access that content 126 and the associated sentiment data determined for that term 172 (e.g., of that enterprises'feed 176) related to that content 126.

In some embodiments, the prompt 194 may be customized for a specific enterprise to form enterprise specific prompt 194a for (e.g., associated with or specific to) that enterprise based on that enterprise's input. It will thus be noted that there may be an enterprise specific prompt 194a for each feed associated with that enterprise. In this manner, an enterprise specific prompt 194a may be both enterprise specific and feed specific.

This customization (also referred to as tailoring or modification of the prompt) may be manually or automatically performed and may be performed in a static or dynamic manner. For example, the language of a prompt for the LLM that resulted in sentiment data for an article may be presented in enterprise interface 112 (e.g., in association with the article and sentiment data determined for a term with respect to that article). Enterprise interface 112 may provide the ability for a user associated with an enterprise to modify the language of the prompt itself. These modifications may include, for example, specific examples or definitions of what the enterprise considers positive or negative sentiment for a their particular enterprise, a particular term or a particular feed. This modified language may be incorporated into the language of the (e.g., generic prompt 194 or a previous version of an enterprise specific prompt 194a) to form the enterprise specific prompt 194a.

This enterprise specific prompt 194a may be utilized next time sentiment data is determined for an article of content 126 with respect to that enterprise's feed 176 such that it is this enterprise specific prompt 194a (e.g., that is also specific for that feed) that is modified or added to based on a term 172, the description 174 of that term 172 and the content 126 of the article to generate the tailored prompt adapted for determining the desired sentiment data for that term 172 with respect to that article.

An enterprise specific prompt 194a may also be generated by sentiment module 114 based on feedback or other input provided by (or determined about) the enterprise (e.g., through enterprise interface 112). For example, a user may provide input related to presented sentiment data such as correcting (or otherwise providing data related to) a sentiment polarity or intensity or may provide updated rationale data (e.g., an identifier whether that rationale is correct or incorrect, or natural language data related to that rationale, such as a description of why the user corrected such sentiment data (or what a correct rationale is). FIG. 2D depicts an example interface that may be presented by a sentiment analysis system to allow a user to edit or otherwise provide their own sentiment and associated rationale in association with an article.

This user input sentiment data can be utilized by sentiment module 114 to create, or update, an enterprise specific prompt 194a. In this manner, as more sentiment data is determined for an enterprise and as (user) input from that enterprise is received in relation to such sentiment data, the enterprise specific prompt 194a may be continually updated and refined to provide more accurate sentiment data for that enterprise in the future. Appendix B presents an example of adding specific instructions to the prompt to account for feedback from users that a previously presented sentiment is incorrect.

It will be noted here, that while embodiments may create enterprise specific prompts 194a for each of one or more enterprises (or feeds 175 for those enterprises), other embodiments may create even more detailed enterprise specific prompts. For example, certain embodiments may create an enterprise and term specific prompt such that for each term 172 of an enterprise's feed 176 there may be an associated enterprise and term specific prompt to utilize for determining sentiment data associated with an article for that specific term and enterprise.

In one case, for example, to determine an enterprise specific prompt 194a, a user's input rationale data can be added to the enterprise specific prompt 194a, or may be added to the enterprise specific prompt 194a in association with the content 126 on which the user provided such updated rationale data. In other words, the content 126 along with the user provided sentiment data (e.g., a user provided sentiment polarity, intensity, or rationale) may be added to the enterprise specific prompt 194a such that this content 126 and updated rationale data may be provided as part of a tailored prompt when determining sentiment data (e.g., for that enterprise) for another completely separate article (e.g., and the same, or another, term 172 of that enterprise's feed 176).

Another way that such an enterprise specific prompt 194a may be created and updated automatically by sentiment module 114 is utilizing the LLM 192 itself. Specifically, sentiment module 114 each time user input sentiment data is received from a user in relation to an article and sentiment data provided by sentiment analysis system 110 sentiment module 114 may submit the article, the originally provided sentiment data and the user provided sentiment data along with the original prompt 194 (or some portions of the original prompt) to the LLM 192 (or another LLM) with a prompt asking the LLM 192 to re-write or otherwise provide update language for the prompt itself. This language returned by the LLM 192 can then be added to, or used to create or update enterprise specific prompt 194a for the enterprise. Again, this updated enterprise specific prompt 194a can be utilized next time sentiment data for an article associated with that enterprise is desired.

Data provided by the user through enterprise interface 112 may also be utilized to improve the accuracy of sentiment data generated by sentiment analysis by allowing embodiment of the sentiment module 114 to employ Retrieval-Augmented Generation (RAG) to dynamically tailor the prompt to be submitted to the LLM 192 for a term and an article. In particular, user input sentiment data may be utilized to form datasets of positive sentiment content 126a1 for an enterprise or negative sentiment content 126a2 for an enterprise (other datasets may be possible and are fully contemplated herein, including those that are across multiple terms, are specific to both an enterprise and that enterprise's terms, are specific to an intensity of sentiment, etc.).

For example, these datasets of sentiment content may be specific to any target audiences 178 included in a feed 176, such that there may be (e.g., different) positive sentiment content or negative sentiment content associated with each target audience. These datasets (e.g., positive or negative sentiment content or target audience specific positive or negative sentiment content) can, for example, be provided by a user with respect to the term.

When a tailored prompt for an article is formed for LLM 192 for a term 172 of an enterprises'feed 176 by sentiment module 114, one or more examples of positive sentiment content or negative sentiment content may be retrieved from positive sentiment content dataset 126a1 or negative sentiment content dataset 126a2 and added to the tailored prompt (or submitted to LLM 192 along with the tailored prompt) to generate sentiment data for the article. Appendix C depicts an example and description of such RAG in the context of sentiment analysis system.

Another way to dynamically tailor the prompt that will be submitted to the LLM 192 to determine sentiment data associated with a term 176 of the enterprise's feed 176 for an article may be to use a database 132 comprising external data determined about the enterprise, such as from publicly available information. This database 132 could also include information about the enterprise provided by users of the enterprise itself, including non-publicly available data.

In one embodiment, for example, an ontology 134 of enterprise related data may be determined and stored at the sentiment analysis system 110. This ontology 134 may be searched or otherwise utilized when forming a tailored prompt such that specific data related to the enterprise may be determined and included in the tailored prompt itself. Such data could include, for example, portions of publicly available data associated with the enterprise such as Wikipedia articles, SEC filings, Crunchbase data, etc.

While embodiments have been discussed with respect to updating prompts 194, data provided by the user through enterprise interface 112 may also be utilized to update (e.g., continually training) LLM 192. In particular, as the user provided sentiment data, or other data associated with creating or updating an enterprise specific prompt 194a, is submitted to LLM 192 (e.g., as part of a tailored prompt or separately in a re-training process) the LLM 192 may be substantially continually (re)trained to provide more accurate sentiment data in the future.

As such, it will be apparent that such user input sentiment data may be fed back to LLM 192 to (re)train LLM even in the absence of creating or updating an enterprise specific prompt 194a. For example, such user input sentiment data may be provided to LLM 192 with an indication of the article and the original sentiment data (e.g., polarity, intensity, or rationale) provided by the LLM 192 with an indication to the LLM 192 that the original data was correct, incorrect, partially correct and partially incorrect, etc. In this manner, the LLM 192 may be substantially continually (re)trained to provide more accurate sentiment data in the future even when such enterprise specific prompts 194a are not created.

Additionally, or alternatively, to creating enterprise specific prompts 194a, enterprise specific LLM 192a may be created and updated (e.g., continually trained) for an enterprise based on the input or other feedback data received from users of that enterprise. In particular, as user provided sentiment data or other data is received from users associated with an enterprise, an enterprise specific LLM 192a-192n may be trained for one or more specific enterprises. For example, a generic LLM 192 may be separately stored and siloed at some point and trained with data (e.g., user provided sentiment data, content, etc.) associated with that enterprise or the enterprise feed 176 (e.g., terms 172 or descriptions 174 of that enterprise's feed 176). In this manner, enterprise specific LLM 192a-192n may be trained for an enterprise and used when determining sentiment data for terms 172 and content 126 associated with that enterprise.

Embodiments may also include a self evaluation module 180 in order to determine whether a LLM 192 should be retrained or replaced, or a prompt 194 (e.g., a generic prompt 194 or enterprise specific prompt 194) should be revised or replaced. Here, self evaluation module 180 may include or utilize a set of evaluation LLMs 182. One or more, or all of, evaluation LLMs 182 may, for example, be a set of less complex LLMs than LLM 192 (e.g., generic LLM or enterprise specific LLM 192).

The set of evaluation LLMs 182 can thus be used as a voting system. Specifically, sample content may be chosen and sample sentiment data (e.g., sentiment polarity, intensity and rationale) for sample terms of a sample enterprise fee with respect to that content as produced by LLM 192 (e.g., generic LLM or enterprise specific LLM 192) obtained. Such sample content and associated sample sentiment data may, for example, be determined when actually determining sentiment data for that sample content with respect to the sample terms for a user of the sample enterprise. The sample content, sample sentiment data, sample terms, etc. may be randomly chosen or otherwise determined.

The sample content can then be submitted with a prompt to each of the set of evaluation LLMs 182 to determine evaluation sentiment data related to that content from each of the evaluation LLMs 182 (e.g., sentiment data related to the sample terms associated with the sample feed and sample terms).

Specifically, the sample terms of the sample enterprise's feed, the description of the sample term and the content itself may be utilized to generate a prompt to each of evaluation LLMs 182. The prompt utilized for submission of the sample content to the set of evaluation LLMs 182 may be the same prompt (e.g., based on a generic or enterprise specific prompt) generated when submitting that content to the LLM 192 (e.g., generic LLM or enterprise specific LLM 192), or may be a different prompt, such as a prompt tailored for evaluation of a result generated by another LLM, etc.

The evaluation sentiment data returned from each of the set of evaluation LLMs 182 may then be evaluated against the sample sentiment data (e.g., as returned by LLM 192 for that content). This can entail an evaluation or comparison of the sentiment polarity, intensity or rationale returned by each of the set of evaluation LLMs 182 against the sentiment polarity, intensity or rationale of the sample sentiment data to determine if they are the same or are similar to one another. If the evaluation sentiment data is not the same or similar to the sample sentiment data, the LLM 192 (e.g., generic LLM or enterprise specific LLM 192) may be retrained or the prompt 194 (e.g., a generic prompt 194 or enterprise specific prompt 194) may be revised, replaced or otherwise modified. In some cases, the evaluation or comparison of the evaluation sentiment data returned by each of the set of evaluation LLMs 182 may be based on a voting methodology whereby if the evaluation sentiment data returned by more than some threshold number of the set of evaluation LLMs 182 is not the same or similar to the sample sentiment data the LLM 192 (e.g., generic LLM or enterprise specific LLM 192) may be retrained or the prompt 194 (e.g., a generic prompt 194 or enterprise specific prompt 194) may be revised, replace or otherwise modified.

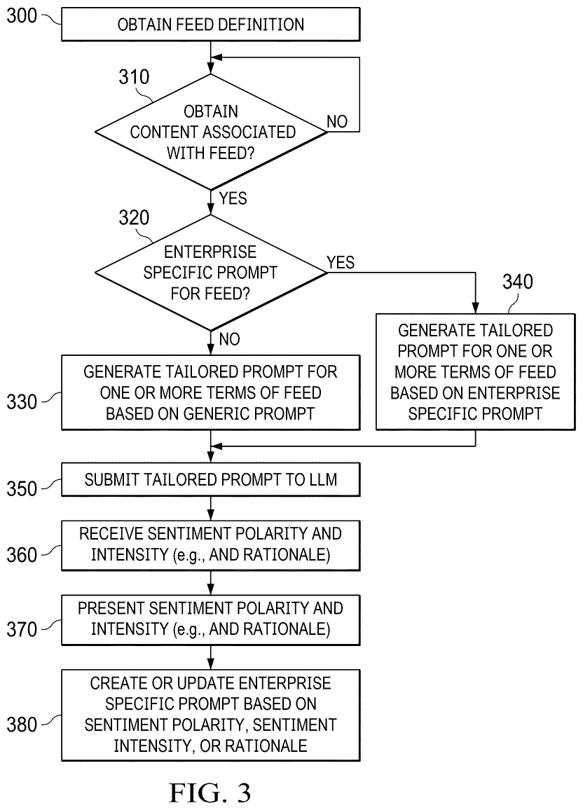

Moving to FIG. 3, one embodiment of a method for sentiment analysis of content based on a feed for an enterprise is depicted. Initially, a definition for a feed can be provided (e.g., by a user associated with an enterprise). This feed definition can comprise a term, a term type, and a term description. In some embodiments, the feed definition may also include one or more target audiences. In some cases, the feed definition may also include a dataset comprising one or more examples of positive or negative sentiment for the term of the feed definition (STEP 300).

Content associated with the feed can then be obtained (Y Branch of STEP 310). Such content may be obtained by searching content associated with one or more content sources for the term to determine content associated with the feed (e.g., at a regular interval), or by otherwise monitoring content sources (or content obtained from such content sources) for content associated with the feed (e.g., term associated with the feed).

When such content is obtained (Y Branch of STEP 310) a prompt for an LLM adapted to cause the LLM to determine sentiment polarity, sentiment intensity or a rationale may be generated. When target audiences are included in feed, the prompt may include the target audience and any associated target audience context in the prompt such that the prompt may be adapted to generate a response from the LLM including the sentiment polarity, intensity for the keyword with respect to each target audience of the feed, or a rationale (e.g., associated with the content) for each of the target audiences.

To generate such a prompt it can be determined if there is an enterprise specific prompt associated with that feed (STEP 320). When there is not an enterprise specific prompt associated with the feed (N Branch of STEP 320) a generic prompt for the content may be generated by modifying a generic prompt to generate a tailored prompt for the content based on the feed using the term, term type, term description, target audience, or other feed data associated with the feed (STEP 330). This tailored prompt may include the content itself or select portions of the content.

When there is an enterprise specific prompt associated with the feed (Y Branch of STEP 320), the enterprise specific prompt may be modified to generate a tailored prompt for the content using the content or any additional feed data such as the term, term type, term description, target audience, or other feed data associated with the feed (STEP 340). Again, this tailored prompt may include the content itself or select portions of the content.

In certain embodiments, generating the tailored prompt comprises presenting a generated prompt to the user, receiving a modification to the prompt from the user, and modifying the prompt according to the modification received from the user. Generating the tailored prompt may also include obtaining sentiment data for a dataset of positive sentiment content or negative sentiment content and including the dataset in the tailored prompt. This dataset can, for example, be provided by a user with respect to the term in a feed definition, at a later point, or with respect to the analysis of other content.

In either case, the generated tailored prompt is adapted to cause the LLM to generate the sentiment polarity, sentiment intensity or rationale for the content based on the contextual use of the term in the content. Again, in certain embodiments, the tailored prompt may be adapted to cause the LLM to generate the sentiment polarity, sentiment intensity or rationale for the content based on the contextual use of the term in the content with respect to each target audience of the feed.

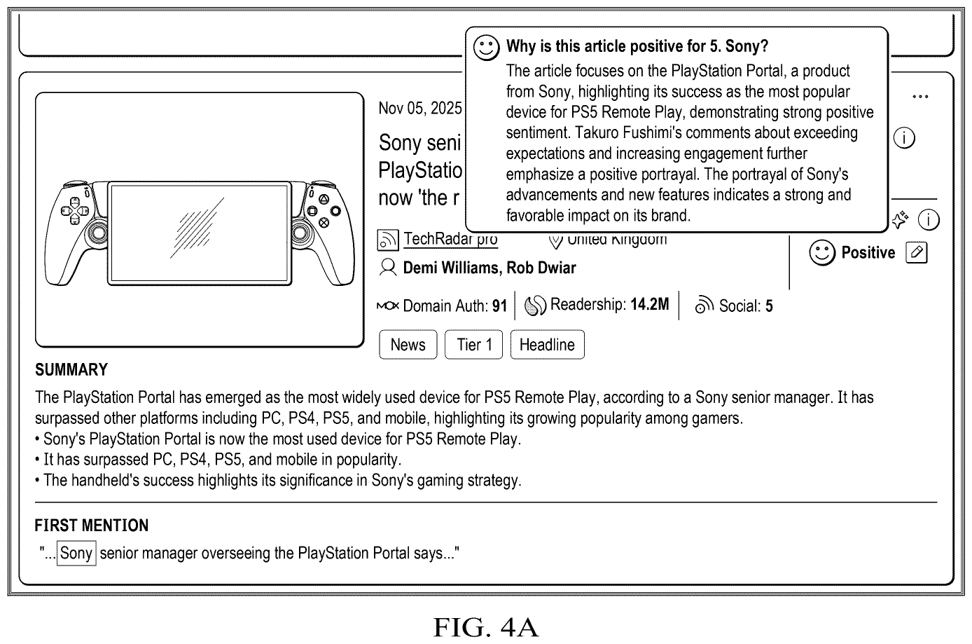

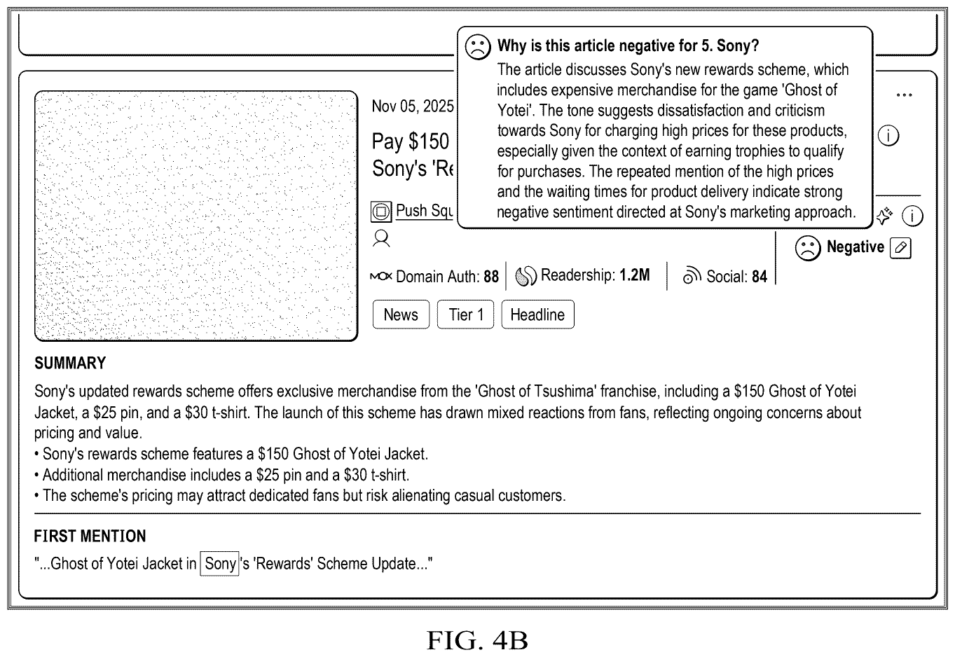

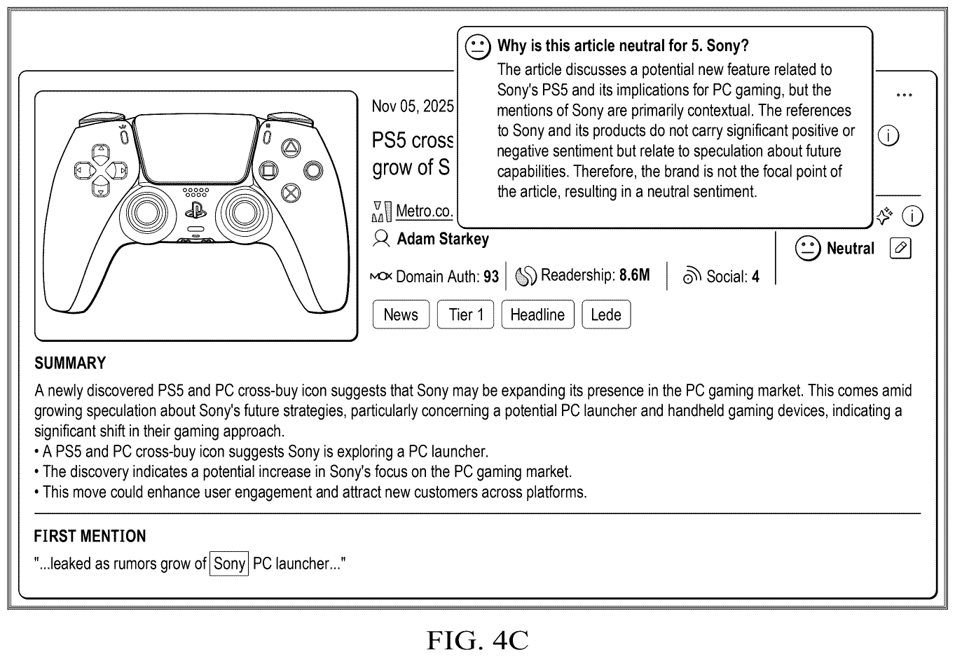

This tailored prompt can then be submitted to the LLM (STEP 350) and the sentiment polarity, sentiment intensity or rationale received from the LLM (STEP 360) presented (e.g., to a user in an interface) (STEP 370). FIGS. 4A-4C depict examples of interfaces that may be utilized or presented by embodiment of a sentiment analysis system, where FIG. 4A is an example of interface presenting a sentiment polarity (e.g., positive) and rationale for the term “Sony” as determined for a piece of content; FIG. 4B is an example of interface presenting a sentiment polarity (e.g., negative) and rationale for the term “Sony” as determined for another piece of content; and FIG. 4C is an example of interface presenting a sentiment polarity (e.g., neutral) and rationale for the term “Sony” as determined for still another piece of content.

An enterprise specific prompt for the feed (or the term of the feed) can then be created or updated (STEP 380) and stored in association with the feed. This creation or update may be based on the sentiment polarity, sentiment intensity or rationale received from the LLM for the content, a user's evaluation of, or input related to, the sentiment polarity, sentiment intensity or rationale presented in association with the content or based on other data related to sentiment analysis or user input related to such sentiment analysis. This created or updated enterprise specific prompt can then be utilized to generate a prompt for the LLM for subsequent sentiment analysis performed on content.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. For example, it will be understood that while embodiments as discussed herein are presented in the context of a browser based application other embodiments may be applied with equal efficacy to other types of components on a computing device (e.g., other native components, etc.).

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

Embodiments will be better understood with reference to the Appendices included hereinbelow, which depicts an example of a term and associated description, an article, a tailored prompt for that article and output from submission of that prompt to an LLM according to one embodiment.

### APPENDIX A

### Feed Term:

Geico

### Feed Term Type:

Organization

### Feed Term Description:

Provides affordable auto insurance and various coverage options nationwide.

### Headline:

Corebridge Financial continues to outperform Berkshire Hathaway Class A by 11.7% year to date.

### Content:

Publish Date: 19 Nov. 2024 12:00
Length: 851 words
NYSE STOCK REPORT
Corebridge Financial's share price is continuing to outperform that of Berkshire Hathaway Class A. Corebridge Financial's return year to date has been 42.2% and Berkshire Hathaway Class A's return has been 30.5% over the same period.

Here is how Corebridge Financial and Berkshire Hathaway Class A compare:
Company Name 1 Month % 3 Month % YTD % Corebridge Financial 0.5 9.8 42.2 Berkshire Hathaway Class A 3.4 6.1 30.5 COREBRIDGE FINANCIAL (CRBG) Stock Dashboard [traded in US Dollars, USD] End-of-Day Mon, November 18
www.corebridgefinancial.com

Last $30.80 52-Week Price Range 18.57-34.10 Ave Daily Volume 4,173,159 shares Today's Volume [VI] 4,385,000 [1.1] Market Cap $18 billion Exchange NYSE [New York] P/E 17.9 EPS (FY2023) $1.72 EPS Growth (FY2023 vs FY2022)-86.4% Shares Outstanding 568,870,000 Institutional Ownership % of shares outstanding 47.1% Dividend Yield % (TTM) 3 DPS (past 12 months) $ 0.5 or 46 c Sector Insurance [of 61 stocks] PV$1000 (1 yr) and TRS $1,702; 70.2% VI* Volume Index=Number of shares traded today/Average number of shares traded per day.

A year ago the Corebridge Financial share price was $18.76. $1,000 would have bought 53.3 Corebridge Financial shares on that day. Those 53.3 Shares would be worth $1,641 at today's share price of $30.80. Dividends reinvested are worth $61. PV$1000=$1,702.

### Activities

Corebridge Financial, Inc. is a provider of retirement solutions and insurance products in the United States. The Company partners with financial professionals and institutions to help individuals plan, save for and achieve secure financial futures. The Company's Individual Retirement segment consists of fixed annuities, fixed index annuities, variable annuities, and retail mutual funds. Its Group Retirement segment consists of record-keeping, plan administrative and compliance services, financial planning and advisory solutions offered in-plan, along with proprietary and limited non-proprietary annuities, advisory and brokerage products offered out-of-plan. Its Life Insurance segment includes products in the United States, including term life and universal life insurance. Its Institutional Markets segment consists of stable value wrap (SVW) products, structured settlement, and pension risk transfer (PRT) annuities, corporate markets products and guaranteed investment contracts (GICs). It is the NYSE's 12th largest Insurance company by market capitalisation.

### COREBRIDGE FINANCIAL PRESS RELEASES AND CORPORATE WIRE

November 7: Corebridge Financial quarterly dividends steady Corebridge Financial today announced a quarterly dividend of 23.0 c per share for Q3/2024; unchanged from the previous quarter (Q2/2024) dividend of 23.0 c. The ex-dividend date is Tuesday, Dec. 17, 2024, and the record date is Tuesday, Dec. 17, 2024, and it is payable on Tuesday, December 31. Total dividends per share paid in the 12 months ended November 8 were 92.0 c. This reflects actual dividend yield of 2.8% at the last price of $33.37.

### BERKSHIRE HATHAWAY CLASS A PRESS RELEASES AND CORPORATE WIRE

September 12: Ajit Jain, Buffett's insurance leader for nearly 40 years, dumps more than half of Berkshire stake.

Ajit Jain, Warren Buffett's insurance chief and top executive, sold more than half of his stake in Berkshire Hathaway, a new regulatory filing showed.

The 73-year-old vice chairman of insurance operations dumped 200 shares of Berkshire Class A shares on Monday at an average price of $695,418 per share for roughly $139 million. That left him holding just 61 shares, while family trusts established by himself and his spouse for the benefit of his descendants hold 55 shares and his nonprofit corporation, the Jain Foundation, owns 50 shares. Monday's sale represented 55% of his total stake in Berkshire.

The move marked the biggest decline in Jain's holdings since he joined Berkshire in 1986. It's unclear what motivated Jain's sales, but he did take advantage of Berkshire's recent high price. The conglomerate traded above $700,000 to hit a $1 trillion market capitalization at the end of August. “This appears to be a signal that Ajit views Berkshire as being fully valued,” said David Kass, a finance professor at the University of Maryland's Robert H. Smith School of Business. It's also consistent with a significant slowdown in Berkshire's share buyback activity as of late. Omaha, Nebraska-based Berkshire repurchased just $345 million worth of its own stock in the second quarter, significantly lower than the $2 billion repurchased in each of the prior two quarters.

“I think at best it is a sign that the stock is not cheap,” said Bill Stone, CIO at Glenview Trust Co. and a Berkshire shareholder. “At over 1.6 times book value, it is probably around Buffett's conservative estimate of intrinsic value. I don't expect many, if any, stock repurchases from Berkshire around these levels.”

The India-born Jain has played a crucial role in Berkshire's unmatched success. He facilitated a push into the reinsurance industry and more recently led a turnaround at Geico, Berkshire's crown jewel auto insurance business.

Created by www.buysellsignals.com Click http://www.buysellsignals.com

### Prompt:

Input:
Keyword Name: {keyword_name}
Keyword Description: {keyword_description}
Headline: {title}
Text Body: {description}

You are an expert analyst tasked with determining the sentiment polarity (negative, positive, neutral) and the intensity (on a scale of 1 to 5) of a news article specifically in reference to the keyword and keyword description provided.

Carefully analyze the content with the following guidelines:
Keyword-Specific Sentiment: Focus your analysis on how the article portrays the specific keyword. Pay attention to context of the entire article and the context the keyword is mentioned,
described, and the associated actions or opinions about the keyword.

Ensure that your sentiment assessment considers if the keyword is central to the topic of the article. Automatically classify any article's polarity as Neutral with an Intensity of 1 when the Keyword is only mentioned 1 or 2 times in the article and is not the central topic or related to the overall topic of the article at all contextually.

Contextual Understanding: Consider the broader context in which the keyword is discussed. Be aware of sarcasm, irony, or complex narratives that might alter the perceived sentiment towards the keyword. Account for both explicit and implicit sentiments strictly related to the keyword and the context relevant to the keyword.

Domain-Specific Language: Be mindful of specialized jargon, euphemisms, or diplomatic language that might affect the sentiment towards the keyword. Recognize how domain-specific terms might influence the interpretation of sentiment.

Bias Awareness: Watch for potential biases in the language or presentation of the keyword. Consider cultural, social, or political nuances that might affect the sentiment. Avoid letting any pre-existing biases in the language influence your judgment.

Granularity of Sentiment: Evaluate sentiment at different levels:
sentence-level sentiment when the keyword is mentioned,
section-level sentiment for portions of the article focused on the keyword,
and aspect-level sentiment if multiple facets of the keyword are discussed.

Track how sentiment towards the keyword might shift throughout the article.

Headline vs. Content: Analyze how the keyword is portrayed in both the headline and the body of the article. Consider the increased significance of the keyword if it is in the headline of the article or mentioned at least 3 times or more in the content of the article.

Ensure that the sentiment is not unduly influenced by potentially sensationalized or clickbait headlines.

Your final sentiment should reflect the portrayal of the keyword in the entire article, as long as the keyword is contextually relevant to the articles central theme.

Neutrality and Mixed Sentiments: Identify if the sentiment towards the keyword is neutral or if there are mixed sentiments. Carefully evaluate the balance of positive, negative, and neutral sentiments in relation to the keyword.

Temporal Dynamics: Consider whether the sentiment towards the keyword evolves throughout the article. Be cautious of assigning a static sentiment to a keyword if the narrative or context around the keyword changes.

Output: Provide your sentiment polarity (negative, positive, neutral) specifically in reference to the keyword within the article. Then, assign an intensity score from 1 to 5, with 1 being very weak and 5 being very strong, based on the overall emotional impact and strength of the sentiment towards the keyword. Include a brief explanation justifying your decision, highlighting any complexities or nuances that influenced your analysis.

It is important to assess how the keyword is being portrayed and NOT the overall sentiment of the article. If the keyword is being portrayed in a positive light, then the score should reflect that even if the general sentiment is negative. For example, if the article is about a natural disaster, but the keyword is being referenced in how they are helping reduce the damage of this disaster, then the polarity would be positive instead of negative.

If the keyword is portrayed in a negative light, then the sentiment should reflect that even if the general sentiment of the article is positive or neutral.

### Audience Aware Prompts:

### Example Prompt with Target Audience

### Input:

Keyword Name: {keyword_name}
Keyword Description: {keyword_description}
Headline: {title}
Text Body: {description}
Audience: {audience}

You are an expert analyst tasked with determining the sentiment polarity (negative, positive, neutral) and the intensity (on a scale of 1 to 5) of a news article specifically in reference to the keyword, keyword description and audience provided. Carefully analyze the content with the following guidelines: Keyword-Specific Sentiment: Focus your analysis on how the article portrays the specific keyword. Pay attention to context of the entire article and the context the keyword is mentioned, described, and the associated actions or opinions about the Keyword.

Ensure that your sentiment assessment considers if the keyword is central to the topic of the article. Automatically classify any article's polarity as Neutral with an Intensity of 1 when the Keyword is only mentioned 1 or 2 times in the article and is not the central topic or related to the overall topic of the article at all contextually.

Contextual Understanding: Consider the broader context in which the keyword is discussed. Be aware of sarcasm, irony, or complex narratives that might alter the perceived sentiment towards the keyword. Account for both explicit and implicit sentiments strictly related to the keyword and the context relevant to the keyword.

Domain-Specific Language: Be mindful of specialized jargon, euphemisms, or diplomatic language that might affect the sentiment towards the keyword. Recognize how domain-specific terms might influence the interpretation of sentiment.

Bias Awareness: Watch for potential biases in the language or presentation of the keyword. Consider cultural, social, or political nuances that might affect the sentiment. Avoid letting any pre-existing biases in the language influence your judgment.

### Granularity of Sentiment:

Evaluate sentiment at different levels: sentence-level sentiment when the keyword is mentioned,
section-level sentiment for portions of the article focused on the keyword,
and aspect-level sentiment if multiple facets of the keyword are discussed.

Track how sentiment towards the keyword might shift throughout the article.

Headline vs. Content: Analyze how the keyword is portrayed in both the headline and the body of the article. Consider the increased significance of the keyword if it is in the headline of the article or mentioned at least 3 times or more in the content of the article.

Ensure that the sentiment is not unduly influenced by potentially sensationalized or clickbait headlines. Your final sentiment should reflect the portrayal of the keyword in the entire article, as long as the keyword is contextually relevant to the articles central theme.

Neutrality and Mixed Sentiments: Identify if the sentiment towards the keyword is neutral or if there are mixed sentiments. Carefully evaluate the balance of positive, negative, and neutral sentiments in relation to the keyword.

Temporal Dynamics: Consider whether the sentiment towards the keyword evolves throughout the article. Be cautious of assigning a static sentiment to a keyword if the narrative or context around the keyword changes.

Output: Provide your sentiment polarity (negative, positive, neutral) specifically in reference to the keyword within the Article, for the given audience. Then, assign an intensity score from 1 to 5, with 1 being very weak and 5 being very strong, based on the overall emotional impact and strength of the sentiment towards the keyword. Include a brief explanation justifying your decision, highlighting any complexities or nuances that influenced your Analysis, including how the given audience influenced your Analysis.

It is important to assess how the keyword is being portrayed and NOT the overall sentiment of the article. If the keyword is being portrayed in a positive light, then the score should reflect that even if the general sentiment is negative. For example, if the article is about a natural disaster, but the keyword is being referenced in how they are helping reduce the damage of this disaster, then the polarity would be positive instead of negative.

If the keyword is portrayed in a negative light, then the sentiment should reflect that even if the general sentiment of the article is positive or neutral.

### Example Prompt With Audience (Stakeholder) Breakdown Input

Keyword Name: {keyword_name}
Keyword Description: {keyword_description}
Headline: {title}
Text Body: {description}

You are an expert analyst tasked with determining the sentiment polarity (negative, positive, neutral) and the intensity (on a scale of 1 to 5) of a news article for different stakeholders, specifically in reference to the keyword and keyword description Provided.

The stakeholders to consider are Consumers, Customers, Employees, Journalists, Investors, and Regulators.

Carefully analyze the content with the following guidelines: Keyword-Specific Sentiment: Focus your analysis on how the article portrays the specific keyword. Pay attention to context of the entire article and the context the keyword is mentioned, described, and the associated actions or opinions about the Keyword.

Stakeholder-Specific Sentiment: Analyze sentiment for each applicable stakeholder. Consider if the overall article sentiment towards the keyword is different for the different stakeholders.

Ensure that your sentiment assessment considers if the keyword is central to the topic of the article. Automatically classify any article's polarity as Neutral with an Intensity of 1 when the Keyword is only mentioned 1 or 2 times in the article and is not the central topic or related to the overall topic of the article at all contextually.

Contextual Understanding: Consider the broader context in which the keyword is discussed. Be aware of sarcasm, irony, or complex narratives that might alter the perceived sentiment towards the keyword. Account for both explicit and implicit sentiments strictly related to the keyword and the context relevant to the keyword.

Domain-Specific Language: Be mindful of specialized jargon, euphemisms, or diplomatic language that might affect the sentiment towards the keyword. Recognize how domain-specific terms might influence the interpretation of sentiment.

Bias Awareness: Watch for potential biases in the language or presentation of the keyword. Consider cultural, social, or political nuances that might affect the sentiment. Avoid letting any pre-existing biases in the language influence your judgment.

### Granularity of Sentiment:

Evaluate sentiment at different levels:
sentence-level sentiment when the keyword is mentioned,
section-level sentiment for portions of the article focused on the keyword,
and aspect-level sentiment if multiple facets of the keyword are discussed.

Track how sentiment towards the keyword might shift throughout the article.

Headline vs. Content: Analyze how the keyword is portrayed in both the headline and the body of the article. Consider the increased significance of the keyword if it is in the headline of the article or mentioned at least 3 times or more in the content of the article.

Ensure that the sentiment is not unduly influenced by potentially sensationalized or clickbait headlines. Your final sentiment should reflect the portrayal of the keyword in the entire article, as long as the keyword is contextually relevant to the articles central theme.

Neutrality and Mixed Sentiments: Identify if the sentiment towards the keyword is neutral or if there are mixed sentiments. Carefully evaluate the balance of positive, negative, and neutral sentiments in relation to the keyword.

Temporal Dynamics: Consider whether the sentiment towards the keyword evolves throughout the article. Be cautious of assigning a static sentiment to a keyword if the narrative or context around the keyword changes.

Output: Provide your sentiment polarity (negative, positive, neutral) for each stakeholder specifically in reference to the keyword within the Article. Then, assign an intensity score from 1 to 5, with 1 being very weak and 5 being very strong, based on the overall emotional impact and strength of the sentiment towards the keyword. Include a brief explanation justifying your decision, highlighting any complexities or nuances that influenced your Analysis.

It is important to assess how the keyword is being portrayed and NOT the overall sentiment of the article. If the keyword is being portrayed in a positive light, then the score should reflect that even if the general sentiment is negative. For example, if the article is about a natural disaster, but the keyword is being referenced in how they are helping reduce the damage of this disaster, then the polarity would be positive instead of negative.

If the keyword is portrayed in a negative light, then the sentiment should reflect that even if the general sentiment of the article is positive or neutral.

Output (Based on the First Prompt or Non-Audience Aware Prompt) {‘polarity’: ‘neutral’, ‘intensity’: 1.0, ‘rationale’: “The keyword ‘Geico’ is mentioned only once in the context of Ajit Jain's role in leading a turnaround at Geico, which is described as Berkshire's ‘crown jewel auto insurance business.’ However, the article primarily focuses on the performance comparison between Corebridge Financial and Berkshire Hathaway, with no detailed discussion or sentiment expressed specifically about Geico. Therefore, the sentiment towards Geico is neutral, with an intensity score of 1 due to its minimal mention and lack of central relevance to the article's main topic.”}.

### Prompt:

**Inputs**:
   Brand Term(s): {brand_terms}
   Brand Term Description(s): {brand_descriptions}
   Headline: {headline}
   Text Body: {content}
   *Task:** You are an expert analyst tasked with determining the sentiment polarity (negative, positive, neutral) and the intensity (on a scale of 1 to 3) of a news article specifically in reference to the Brand Term and Brand Term description provided.
   *Intensity (Strength) Scale**
      **1 (weak)**—Brief or low-stakes impact (passing mention, mild phrasing, low prominence).
      **2 (moderate)**—Brand Term is discussed with a clear tone but stakes/impact are moderate.
      **3 (strong)**—Repeated, explicit praise/criticism or high-stakes claims (lawsuits, major awards, crises, breakthrough successes) with strong language and/or high prominence (headline/lede
   *Mandatory Rules:**
      Automatically classify any article's polarity as Neutral with an Intensity of 1 when the Brand Term is only mentioned
   1 or 2 times in the article and is not the central topic or related to the overall topic of the article at all contextually.
If the Brand Term is being portrayed in a positive light, then the score should reflect that even if the general sentiment is negative. Example: if the content is about a disaster or humanitarian crisis, but the Brand Term is being referenced as helping the victims then the polarity would be positive instead of negative for the Brand Term.
Assign Neutral sentiment If the Brand Term is mentioned as the source of information from a report, survey, data, research, cited or quoted to support the telling of the story's overall narrative, even if the overall narrative is negative. Example: the Brand Term is a cyber security company who identified and stopped a data breach.
Assess specifically how the Brand Term is being portrayed throughout the article and NOT the overall sentiment of the article.
**Carefully analyze the content with the following guidelines:**
   Brand Term-Specific Sentiment: Focus your analysis on how the article portrays the specific Brand Term.
   Pay attention to the context of the entire article and the context in which the Brand Term is mentioned, described, and the associated actions or opinions about the Brand Term.
   Contextual Understanding: Consider the broader context in which the Brand Term is discussed.
   Be aware of sarcasm, irony, or complex narratives that might alter the perceived sentiment towards the Brand Term.
Account for both explicit and implicit sentiments strictly related to the Brand Term and the context relevant to the Brand Term.
Domain-Specific Language: Be mindful of specialized jargon, euphemisms, or diplomatic language that might

affect the sentiment towards the Brand Term. Recognize how domain-specific terms might influence the interpretation of sentiment.
Bias Awareness:
   Watch for potential biases in the language or presentation of the Brand Term.
   Consider cultural, social, or political nuances that might affect the sentiment.
   Avoid letting any pre-existing biases in the language influence your judgment.
Granularity of Sentiment: Evaluate sentiment at different levels:
   sentence-level sentiment when the Brand Term is mentioned
   section-level sentiment for portions of the article focused on the Brand Term,
   aspect-level sentiment if multiple facets of the Brand Term are discussed.
Track how sentiment towards the Brand Term might shift throughout the article.
Headline vs. Content: Analyze how the Brand Term is portrayed in both the headline and the body of the article.
   Ensure that the sentiment is not unduly influenced by potentially sensationalized or clickbait headlines.
Your final sentiment should reflect the portrayal of the Brand Term in the entire article.
Neutrality and Mixed Sentiments: Identify if the sentiment towards the Brand Term is neutral or if there

are mixed sentiments.
Carefully evaluate the balance of positive, negative, and neutral sentiments in relation to the Brand Term.
Temporal Dynamics: Consider whether the sentiment towards the Brand Term evolves throughout the article.
Be cautious of assigning a static sentiment to a Brand Term if the narrative or context around the Brand Term changes.
Output (ONLY Return these 3 fields):
   Assign exactly one sentiment: positive, negative, neutral
   Assign exactly one intensity score: 1, 2 or 3
   Brief explanation justifying your decision, highlighting any complexities or nuances that influenced your analysis in 3-4 sentences.

### APPENDIX B

This example depicts a revised prompt based on a misclassification for AC Engine. This example adds specific instructions to the prompt to account for feedback from users that the sentiment is wrong. In this case the sentiment was wrong because the rationale confused AC Engine with ACMECorp. org and Wiley E. Coyote who is not affiliated with AC Engine.

### Input:

Keyword Name: {keyword_name}
Keyword Description: {keyword_description}
Headline: {title}
Text Body: {description}

You are an expert analyst tasked with determining the sentiment polarity (negative, positive, neutral) and the intensity (on a scale of 1 to 5) of a news article specifically in reference to the keyword and keyword description provided.

Carefully analyze the content with the following guidelines:
Keyword-Specific Sentiment: Focus your analysis on how the article portrays the specific keyword. Pay attention to the context of the entire article, how the keyword is mentioned, described, and the associated actions or opinions about the keyword.

Automatically classify any article's polarity as Neutral with an Intensity of 1 when the keyword is only mentioned 1 or 2 times in the article and is not central to the topic or contextually connected to the overall theme of the article.

Special Consideration for AC Engine: If the keyword is “AC Engine,” be particularly cautious about misclassifying sentiment. AC Engine is often mentioned in technical or industry-specific contexts where sentiment can be misinterpreted. Ensure that you focus on:
Whether AC Engine is portrayed as a subject driving positive or negative outcomes.
Whether AC Engine is shown solving or causing a problem.
Avoid assigning sentiment based on generic or passing mentions of AC Engine unless it is central to the narrative.
Be cautious when AC Engine is mentioned in the context of conflicts or disputes involving third parties (e.g., ACMECorp. org or Wiley E. Coyote). Ensure that negative sentiment is directed specifically at AC Engine and not at the third party.
If negative sentiment in the article is primarily directed at a third party and not AC Engine, the sentiment towards

AC Engine should not be classified as negative. Contextual Understanding: Consider the broader context in which the keyword is discussed. Be aware of sarcasm, irony, or complex narratives that might alter the perceived sentiment towards the keyword. Account for both explicit and implicit sentiments strictly related to the keyword and its relevant context.

Domain-Specific Language: Be mindful of specialized jargon, euphemisms, or diplomatic language that might affect sentiment towards the keyword. Recognize how domain-specific terms might influence interpretation.

Bias Awareness: Watch for potential biases in the language or presentation of the keyword. Consider cultural, social, or political nuances that might affect sentiment. Avoid letting pre-existing biases in the language influence your judgment.

Granularity of Sentiment: Evaluate sentiment at different levels:
Sentence-level sentiment when the keyword is mentioned.
Section-level sentiment for portions of the article focused on the keyword.
Aspect-level sentiment if multiple facets of the keyword are discussed.

Track how sentiment towards the keyword might shift throughout the article.

Headline vs. Content: Analyze how the keyword is portrayed in both a headline and the body of the article. Consider the increased significance of the keyword if it is in the headline of the article or mentioned at least 3 times or more in the content of the article.

Ensure that the sentiment is not unduly influenced by potentially sensationalized or clickbait headlines.

Neutrality and Mixed Sentiments: Identify if the sentiment towards the keyword is neutral or if there are mixed sentiments. Carefully evaluate the balance of positive, negative, and neutral sentiments in relation to the keyword.

Temporal Dynamics: Consider whether the sentiment towards the keyword evolves throughout the article. Be cautious of assigning a static sentiment to a keyword if the narrative or context around the keyword changes. Output: Provide the sentiment polarity (negative, positive, neutral) specifically in reference to the keyword within the article. Then, assign an intensity score from 1 to 5, with 1 being very weak and 5 being very strong, based on the overall emotional impact and strength of the sentiment towards the keyword.

Include a brief explanation justifying your decision, highlighting any complexities or nuances that influenced your analysis.

It is important to assess how the keyword is being portrayed and NOT the overall sentiment of the article. If the keyword is being portrayed in a positive light, then the score should reflect that even if the general sentiment is negative. For example, if the article is about a natural disaster, but the

keyword is being referenced in how they are helping reduce the damage of this disaster, then the polarity would be positive instead of negative.

If the keyword is portrayed in a negative light, then the sentiment should reflect that even if the general sentiment of the article is positive or neutral. If negative sentiment arises from conflicts involving third parties (e.g., ACMECorp. org or Wiley E. Coyote) and not specifically from AC Engine's actions, then AC Engine's sentiment should not be classified as negative.

### APPENDIX C

Embodiments of a Retrieval Augmented Generation (RAG) system can be used to improve sentiment over time for a specific enterprise. The RAG may use a feedback loop where, over time, feedback can be received about the accuracy of the sentiment for the enterprise. This feedback comprises of one or more specific articles where the sentiment was inaccurate, and includes the article headline and content, the original polarity, intensity, and rationale, the new polarity, and a new rationale.

Each instance of feedback received over time is stored in a knowledge database. The prompt may then be modified to use this knowledge database. For example, the following section could be added to the original prompt:
RAG Context Integration: Before sentiment analysis, retrieve relevant historical sentiment analysis cases, keyword-specific examples, or guidelines from the knowledge database. Use retrieved insights to handle ambiguous contexts or keyword misattributions. If retrieved knowledge highlights a recurring misclassification pattern, prioritize correcting for those scenarios in the sentiment classification.

Include insights from the retrieved data in the analysis explanation, particularly if they clarify recurring patterns or provide useful context.

What is claimed is:

1. A method, comprising:
obtaining a definition for a feed associated with content received from one or more data sources, where the definition comprise a term, a term type, and a term description;
obtaining first content associated with the feed; and
determining a sentiment polarity and a sentiment intensity for the term with respect to the first content by:
generating a first prompt for the first content based on the feed using the term, term type, and term description, where the first prompt is adapted to cause a Large Language Model (LLM) to generate the sentiment polarity and sentiment intensity for the first content based on the contextual use of the term in the first content; and
submitting the generated first prompt to the LLM.

2. The method of claim 1, wherein the first prompt is adapted to cause the LLM to generate a rationale for the sentiment polarity or sentiment intensity.

3. The method of claim 1, wherein the definition includes one or more target audiences, and the first prompt is adapted to cause the LLM to generate the sentiment polarity and sentiment intensity for the first content based on the contextual use of the term in the first content for each of the one or more target audiences.

4. The method of claim 1, further comprising generating the first prompt comprises modifying a generic prompt to generate a tailored prompt based on the term, term type, and term description of the feed.

5. The method of claim 4, wherein generating the tailored prompt comprises:
presenting the first prompt to the user;
receiving a modification to the first prompt from the user; and
modifying the first prompt according to the modification received from the user; or
obtaining sentiment data for a dataset of positive sentiment content or negative sentiment content and including the dataset in the tailored prompt.

6. The method of claim 3, further comprising:
storing the tailored prompt as an enterprise and feed specific prompt;
obtaining second content associated with the feed; and
determining the sentiment polarity and the sentiment intensity for the term with respect to the second content by:
obtaining the enterprise and feed specific prompt;
generating a second prompt for the second content based on the enterprise and feed specific prompt using the term, term type, and term description, where the second prompt is adapted to cause the LLM to generate the sentiment polarity and sentiment intensity for the second content based on the contextual use of the term in the second content; and
submitting the generated second prompt to the LLM.

7. The method of claim 6, further comprising:
updating the enterprise and feed specific prompt based on output of the LLM in response to submitting the first prompt to the LLM.

8. A system, comprising:
a processor;
a non-transitory computer readable medium, comprising instructions for:
obtaining a definition for a feed associated with content received from one or more data sources, where the definition comprise a term, a term type, and a term description;
obtaining first content associated with the feed; and
determining a sentiment polarity and a sentiment intensity for the term with respect to the first content by:
generating a first prompt for the first content based on the feed using the term, term type, and term description, where the first prompt is adapted to cause a Large Language Model (LLM) to generate the sentiment polarity and sentiment intensity for the first content based on the contextual use of the term in the first content; and
submitting the generated first prompt to the LLM.

9. The system of claim 8, wherein the first prompt is adapted to cause the LLM to generate a rationale for the sentiment polarity or sentiment intensity.

10. The system of claim 8, wherein the instructions are further for: generating the first prompt comprises modifying a generic prompt to generate a tailored prompt based on the term, term type, and term description of the feed.

11. The system of claim 10, wherein generating the tailored prompt comprises:
presenting the first prompt to the user;
receiving a modification to the first prompt from the user; and modifying the first prompt according to the modification received from the user.

12. The system of claim 10, wherein generating the tailored prompt, comprises:
obtaining sentiment data for a dataset of positive sentiment content or negative sentiment content and including the dataset in the tailored prompt.

13. The system of claim 10, wherein the instructions are further for:
storing the tailored prompt as an enterprise and feed specific prompt;
obtaining second content associated with the feed; and
determining the sentiment polarity and the sentiment intensity for the term with respect to the second content by:
obtaining the enterprise and feed specific prompt;
generating a second prompt for the second content based on the enterprise and feed specific prompt using the term, term type, and term description, where the second prompt is adapted to cause the LLM to generate the sentiment polarity and sentiment intensity for the second content based on the contextual use of the term in the second content; and
submitting the generated second prompt to the LLM.

14. The system of claim 13, wherein the instructions are further for updating the enterprise and feed specific prompt based on output of the LLM in response to submitting the first prompt to the LLM.

15. A non-transitory computer readable medium, comprising instructions for:
obtaining a definition for a feed associated with content received from one or more data sources, where the definition comprise a term, a term type, and a term description;
obtaining first content associated with the feed; and
determining a sentiment polarity and a sentiment intensity for the term with respect to the first content by:
generating a first prompt for the first content based on the feed using the term, term type, and term description, where the first prompt is adapted to cause a Large Language Model (LLM) to generate the sentiment polarity and sentiment intensity for the first content based on the contextual use of the term in the first content; and
submitting the generated first prompt to the LLM.

16. The non-transitory computer readable medium of claim 15, wherein the first prompt is adapted to cause the LLM to generate a rationale for the sentiment polarity or sentiment intensity.

17. The non-transitory computer readable medium of claim 15, wherein the instructions are further for: generating the first prompt comprises modifying a generic prompt to generate a tailored prompt based on the term, term type, and term description of the feed.

18. The non-transitory computer readable medium of claim 17, wherein generating the tailored prompt comprises:
presenting the first prompt to the user;
receiving a modification to the first prompt from the user; and
modifying the first prompt according to the modification received from the user.

19. The non-transitory computer readable medium of claim 17, wherein generating the tailored prompt, comprises obtaining sentiment data for a dataset of positive sentiment content or negative sentiment content and including the dataset in the tailored prompt.

20. The non-transitory computer readable medium of claim 17, wherein the instructions are further for:
storing the tailored prompt as an enterprise and feed specific prompt;
obtaining second content associated with the feed; and
determining the sentiment polarity and the sentiment intensity for the term with respect to the second content by:
obtaining the enterprise and feed specific prompt;
generating a second prompt for the second content based on the enterprise and feed specific prompt using the term, term type, and term description, where the second prompt is adapted to cause the LLM to generate the sentiment polarity and sentiment intensity for the second content based on the contextual use of the term in the second content; and
submitting the generated second prompt to the LLM.

21. The non-transitory computer readable medium of claim 20, wherein the instructions are further for updating the enterprise and feed specific prompt based on output of the LLM in response to submitting the first prompt to the LLM.
